(19) United States
(12) Patent Application Publication
(10) Pub. No.: US 2019/0044922 A1
(43) Pub. Date: Feb. 7, 2019

(54) SYMMETRIC KEY IDENTITY SYSTEMS AND METHODS

(71) Applicant: Rubicon Labs, Inc., San Francisco, CA (US)

(72) Inventors: Roderick Schultz, San Francisco, CA (US); Gerald E Woodcock, III, Austin, TX (US)

(21) Appl. No.: 15/667,476

(22) Filed: Aug. 2, 2017

(51) Int. Cl. H04L 29/06; H04L 9/32

(52) U.S. Cl. CPC H04L 63/0435; H04L 9/3242; H04L 63/067; H04L 63/061

(57) ABSTRACT

Symmetric key identification systems and methods are disclosed herein. An example system includes a distributed device service that distributes, to devices, dynamic portions of the keyed hashing function, the devices embedding static portions of the keyed hashing function and are each configured to create a secret key from pairs of the static portions and the dynamic portions, the secret key used to generate encrypted session keys that are utilized to facilitate secure sessions and trusted relationships between one or more of the devices, the secret key unknown to a processor of the device to which it belongs.

### FIELD OF THE PRESENT TECHNOLOGY

The present disclosure relates to secure device communications, and more particularly, but not by way of limitation, to systems and methods that provision secure symmetric keys to devices. These symmetric keys can be utilized by the devices to effectuate secure communications. Embodiments use symmetric keys that are mirrored in a cloud service.

### SUMMARY

Various embodiments of the present technology include a method for creating a zero-knowledge security key, the method comprising: (a) storing a one-time programmable key in a vault on the first device, the one-time programmable key forming a static portion of a keyed hashing function, wherein the OTP key is usable but unknown to the first device; (b) receiving, from a distributed device service, a dynamic portion of the keyed hashing function from the distributed device service; (c) cryptographically processing the one-time programmable key and the dynamic portion of the keyed hashing function to create a first secret key; and (d) storing the first secret key in the vault.

Various embodiments of the present technology include a method comprising (a) upon initial device activation of a first device, receiving a request to obtain a dynamic portion of a keyed hashing function from the first device, the first device being previously provisioned with a one-time programmable key stored in a hardware component of the first device, the one-time programmable key being a static portion of the keyed hashing function; (b) transmitting the dynamic portion of the keyed hashing function to the first device; (c) receiving a request to establish a trust relationship between the first device and a second device; (d) receiving a set of bits of entropy from the first device (e) processing the set of bits of entropy with a symmetric version of the keyed hashing function for the first device to create a first session key, the first device having also created the first session key; (f) establishing a secure channel with the first device using the first session key; (g) transmitting another set of bits of entropy to the second device, the second device creating a second session key using the another set of bits of entropy; (h) encrypting the second session key with the first session key; and (i) transmitting the encrypted second session key to the second device, wherein the second device can decrypt the encrypted second session key to recover the first session key and establish a secure session with the first device.

Various embodiments of the present technology include a system comprising: (a) a distributed device service that distributes, to devices, dynamic portions of the keyed hashing function, wherein the devices embed static portions of the keyed hashing function, and are each configured to create a secret key from pairs of the static portions and the dynamic portions, further wherein the secret key is used to generate encrypted session keys that are utilized to facilitate secure sessions between one or more of the devices, wherein the secret key is unknown to a processor of the device to which it belongs.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a signal flow diagram of an example method of the present disclosure for provisioning a plurality of secret keys to a plurality of devices, where the secret keys are mirrored in a distributed device service.

FIG. 2 is a flowchart of a method executed by a device that is configured for use according to embodiments of the present disclosure.

FIG. 3 is a signal flow diagram of an example method of the present disclosure that illustrates the establishment of a secure channel of communication between two devices using symmetric session key encryption and decryption.

FIG. 4 is a flowchart of a method executed by a distributed device service that is configured for use according to embodiments of the present disclosure.

FIG. 5 is a schematic diagram of an example method for using a combined key and hashing function.

FIG. 6 is a schematic diagram of a computing system that is used to implement embodiments according to the present technology.

### DETAILED DESCRIPTION

Generally, embodiments of the present disclosure are related to systems and methods that utilize symmetric keys, and specifically zero-knowledge keys to both identify devices and establish secure channels of communication. These secure channels of communication can exist between the devices and a cloud-based service, referred to herein as a distributed device service, and also between authenticated devices.

Embodiments of the present disclosure provide an easily integrated key provisioning and protection platform for devices. Example devices include, but are not limited to, computing systems, telecommunications devices, sensors, automotive microcontrollers (MCUs) and central processing units (CPUs). These devices can include a minimal semiconductor footprint coupled with a hardware root-of-trust. Embodiments incorporate an on-chip solution that can fit into any secure or vulnerable computing environment such as systems within the Internet-of-Things (IoT).

Some embodiments of the present disclosure provide for coupling of a keyed one-way hash function with a secure memory space on the device. This coupling creates a vault that can be provisioned with a secret key whose value is never known by anyone or anything, but still usable by the device. This process produces a self-provisioning zero-knowledge system that can be used as the digital identity of the device. That is, the distributed device service mirrors the secret key of the device. The secret key is the identity of the device within the distributed device service. The algorithms, such as the HMAC function and symmetric encryption, are also mirrored in some embodiments.

Some embodiments implement zero-knowledge keys to prove an assertion without revealing any other information. It will be understood that a semiconductor-enforced sandbox is secure because the MCU/CPU can interact with the secret key in the vault only to write data to the input of the keyed hash function (e.g., secret key) and to read the resulting output.

Thus, even if an attacker gains access to the CPU/MCU, he/she can never access the zero-knowledge key. The address of the secret key within the vault is never readable, keeping the identity of the device secure. Stated otherwise, the device has a secure execution space, so no root key or derived session key is ever in attackable memory. In other embodiments, the secret key can be stored in any suitable memory space on the device, secure or otherwise.

As mentioned above, once zero-knowledge keys are provisioned into the secure execution space of a core of the device, the secure key is mirrored in a cloud-based distributed device service (DDS). Thus, the authenticated identity of the device is brokered through the DDS.

The DDS can be generally described as a powerful identity authority, but the DDS is based on symmetric cryptography (not public key infrastructure). Identities are validated by the DDS, rather than by being validated via device validation using a document and/or certificate. It brokers trust relationships between devices and has a foundation of zero-knowledge keys. These systems and methods solve a key and identity-provisioning problem that has challenged vendors, as deployed device numbers have grown larger. The systems of the present disclosure scale far better than asymmetric/PKI-based keys, and have incredible speeds of execution, which are a requirement for many system and device bus speeds.

For example, a key exchange of the present disclosure can execute 3,000 times faster than an equivalent RSA 2048 bit TLS handshake. This low-power and high-speed feature is critical for many systems, for example RTOS (real-time operating system) requirements of some systems.

The systems and methods disclosed herein complement implementations that rely on secure identity by deriving session keys between other similarly constructed devices and servers. These session keys are all zero-knowledge based, execute in a secure execution space, and allow for authentication, data encryption, and secure execution of signed binaries that are delivered from the cloud.

In an example use case in the automotive arts, these systems and methods can prevent malicious attacks that use identity spoofing, data manipulation, code/binary replacement, and cloning—just to name a few. These attacks are possible, and even simple, due to a lack of secure identity, secure communication, and secure execution of MCUs on the CAN bus.

With regard to the construction of devices that are capable of using the symmetric zero-knowledge keys of the present disclosure, each device has a one-time programmable key burned into its silicon when it is fabricated. This key represents half of a dual 256 bit zero-knowledge hardware secret key, referred to also herein as a portion of the “keyed hashing function.” In general, the keyed hashing function comprises multiple parts, including a hashing function which comprises a compression function, and a hashing key (e.g., HMAC key).

The one-time programmable key is referred to as a static portion of the keyed hashing function/secret key. In other embodiments, the device already comprises an aspect of uniqueness such as entropy from the silicon. An example of this would be a PUF—Physically Unclonable Function. This example allows the methods disclosed herein to rely on entropy that comes naturally from the device. Also, the use of other sized keys is contemplated in accordance with the present disclosure, allowing for different key strength requirements or preferences.

Secure session keys can be derived from this same structure, creating zero-knowledge keys. A dynamic portion of the zero-knowledge key is provisioned by contacting the DDS of the device. Once contacted, signed entropy is sent to the device and subsequently used for zero-knowledge key derivation. In one example, the signed entropy comprises a randomly generated set of numerical characters.

Once the secret key is set the first time, the server-supplied entropy input may be saved along with its signature to a local persistent storage device. This allows the device to re-initialize the secret key on subsequent power cycles without having to communicate again with the DDS.

Device activation is designed for distributed cooperation with untrusted parties (e.g., devices). This prevents any one party from having full control of device activation, and addresses any concerns with single points of compromise for cryptographic activation keys.

Distributed device activation is accomplished by building on zero-knowledge key derivatives, along with cryptographic key splitting. No single part of the activation key can be used without assembling it from multiple independently sourced parts. A policy can be defined to allow for a threshold of keys to be available (N of M in a set) before key reconstruction is mathematically possible.

This allows a hardware vendor to have an untrusted relationship with a service provider, but still enable secure activation across multiple independent security boundaries.

In some embodiments, the DDS can be leveraged as a powerful identity authority. It brokers trust relationships between devices and has a foundation of zero-knowledge keys. This is a simplification to the key and identity-provisioning problem that has challenged vendors as networks have grown.

Embodiments of the present disclosure are fully portable and interoperable with any CPU architecture because it secures data, not addresses. Again, the features of the present disclosure are not limited to devices that possess secure or trusted execution environments. Embodiments can be built with NIST algorithms and do not require new CPU instructions or compilers. If an IoT device requires security, then these systems and methods are designed to provide it.

Once provisioned with a zero-knowledge key, a secure identity is built on top of it. Identity verification and management can then be used for authentication, authorization, and secure communication.

As mentioned above, identity management can be accomplished by brokering relationships through the DDS. The DDS has the ability to recreate and use the zero-knowledge keys it has provisioned to the individual devices. This DDS provides identity and trust to the network, and once trust has been brokered between two devices, independent and secure communication is unlocked and enabled.

These and other aspects of the present disclosure will be disclosed in greater detail below with reference to the collective drawings.

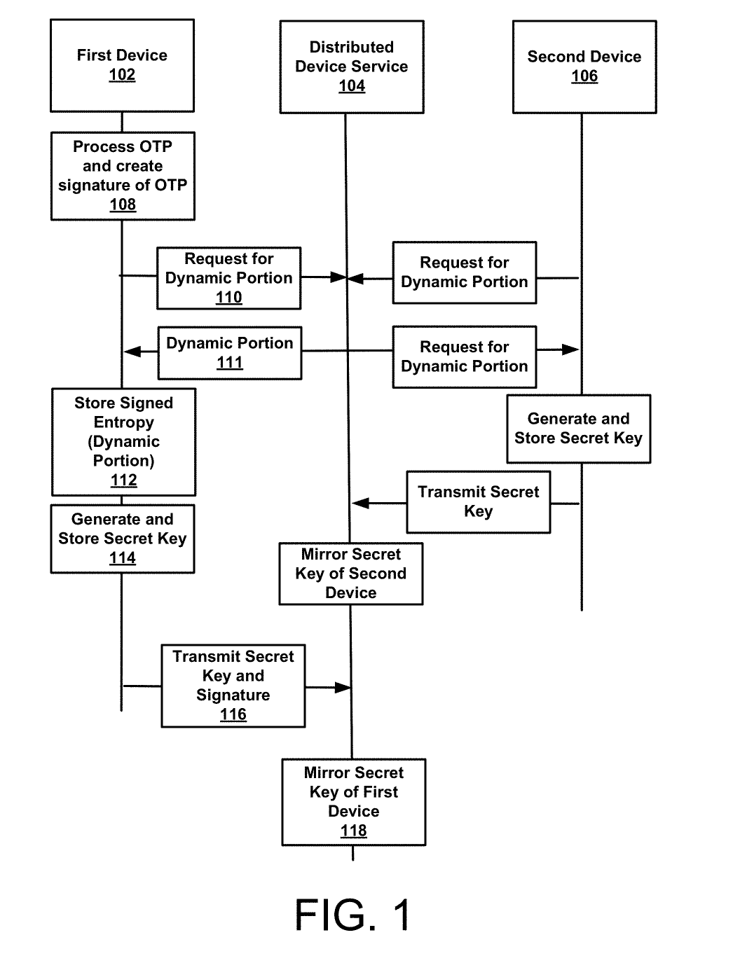

FIG. 1 illustrates an example signal flow diagram of a method for provisioning a secret key to one or more devices. The method is conducted between a first device 102, a DDS 104, and a second device 106. The DDS 104 can mediate this method for any number of devices.

Prior to execution of the method, each device can be manufactured in such a way that a one-time programmable (OTP) key is written into a hardware component of the device. For example, an OTP key can be stored in a secure memory space of a first device 102. The OTP key is a static portion of a keyed hashing function of the first device 102. In some embodiments, the OTP is a randomly generated number generated by the DDS 104. This randomly generated value is referred to as a first value or first random number (first set of bits of entropy).

In some embodiments, the OTP is stored within an HMAC function that is capable of implementing hashing functions such as SHA1, SHA2, SHA3, or other similar hashing functions. The OTP can include any bits of information in sizes ranging up to 256 bits or more.

In some embodiments, the first device 102 can include a step 108 of processing the OTP with the resident HMAC function to create a signature of the OTP. This creates a signature that can be used along with the OTP by the DDS 104 to verify/authenticate the first device 102. This process creates what is referred to as an HMAC secret.

In some embodiments, devices are provisioned with advanced encryption service (AES). The OTP key and AES each provide a means for accessing secure communication with the device. Possession of the OTP key and a corresponding signature allows the first device 102 to establish bilateral communication between the first device 102 and the DDS 104, while the AES allows for devices to establish bilateral communication, such as between the first device 102 and the second device 106, using symmetric session keys, as will be discussed in greater detail herein.

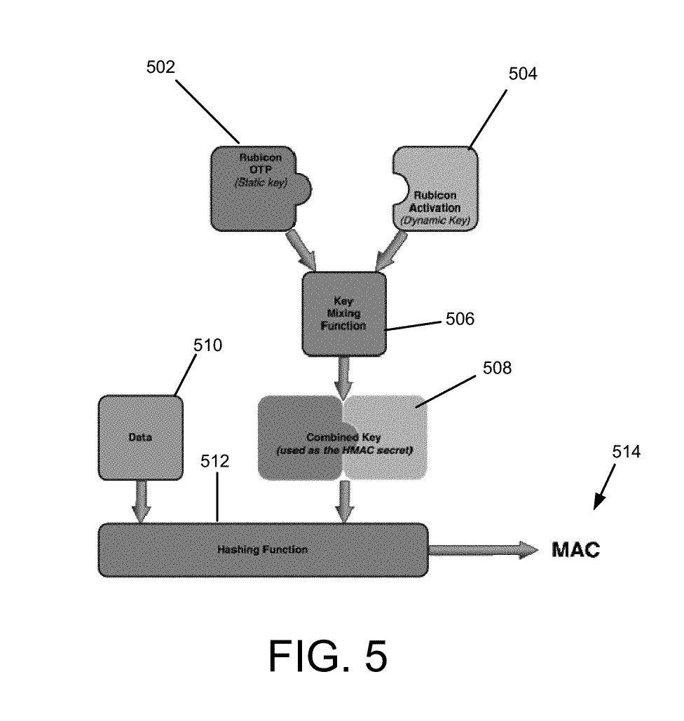

In general, the keyed hashing function for a device comprises two parts. The keyed hashing function includes the static portion that is the OTP key. Another part is a dynamic portion that is received from the DDS 104. In one embodiment, the dynamic portion is signed entropy such as a randomly generated number created by the DDS 104. Yet another part of the keyed hashing function comprises the hashing function that is the compressing function. Thus, the OTP key, signed entropy, and hashing function are all utilized to create a symmetric key. The signed entropy and hashing function comprise the dynamic portion of the keyed hashing function. An example method for using a static key portion and a dynamic key portion is illustrated in FIG. 5, which is described below in greater detail.

When the first device 102 is initialized and connected to a network (can include any suitable network, public or private), the first device 102 transmits a request for the dynamic portion of the keyed hashing function to the DDS in step 110. This request includes the HMAC secret that includes the signature of the OTP key and the OTP key.

As the DDS 104 stores a mirrored value of the OTP key and signature, the DDS 104 confirms that the OTP key is authentic and responds with the dynamic portion in step 111. In some embodiments, the DDS 104 does not verify the authenticity of the OTP of the first device 102 and will transmit signed entropy to any device requesting such from the DDS 104. This dynamic portion of the keyed hashing value is referred to in some instances as a second random number (second set of bits of entropy) or second value.

In some embodiments, the DDS 104 creates a mirror of OTPs, keyed hashing functions, symmetric session keys, and other data generated by and for the devices using the DDS 104.

In some embodiments, the first device 102 can store the entropy input (e.g., dynamic portion) along with its signature to a local persistent storage device in step 112. Once the dynamic portion is received, the static and dynamic portions are processed by the first device 102 to create a secret key in step 114, referred to also as the keyed hashing function. This keyed hashing function is a means for generating symmetric session keys. A symmetric session key is a secure key that allows the first device 102 to communicate with other zero-knowledge key devices.

According to some embodiments, the secret key is created when the static portion and the dynamic portion, which can both include randomly generated numbers, are subjected to an XOR cipher algorithm creating a resultant value from the two numbers. The resultant XOR value is encrypted using the AES provisioned on the first device 102. Other suitable algorithms can be utilized in combination with, or in place of, the XOR cipher algorithm.

In some embodiments, the secret key can be mirrored at the DDS 104 by the first device 102 transmitting the secret key to the DDS 104 as in step 116. In another example embodiment, the DDS 104 can create the mirrored secret key using the static portion of the keyed hashing function in combination with the signed entropy generated for the first device 102. The DDS 104 mirrors the secret key of the first device in step 118.

The process executed between the first device 102 and the DDS 104 can be repeated for as many devices as necessary. For example, in a manufacturing facility that houses hundreds or thousands of independent devices, the method above can be used to create secret keys for each of the devices. It will be understood that the use of signed entropy when creating a secret key results in uniqueness of the secret key (e.g., keyed hashing function). Thus, as the secret key is bound in secure memory space of the device, the secret key can be used to identify the device within the DDS 104.

In one embodiment, the second device 106 is also provisioned with a secret key. As illustrated the second device does not store the signed entropy (e.g., dynamic portion) of the keyed hashing function, although in some embodiments it may.

Once the secret key is established and mirrored in the DDS 104, the DDS 104 can act as an authenticated entity broker to establish secured sessions of communication by symmetric encrypted key exchange.

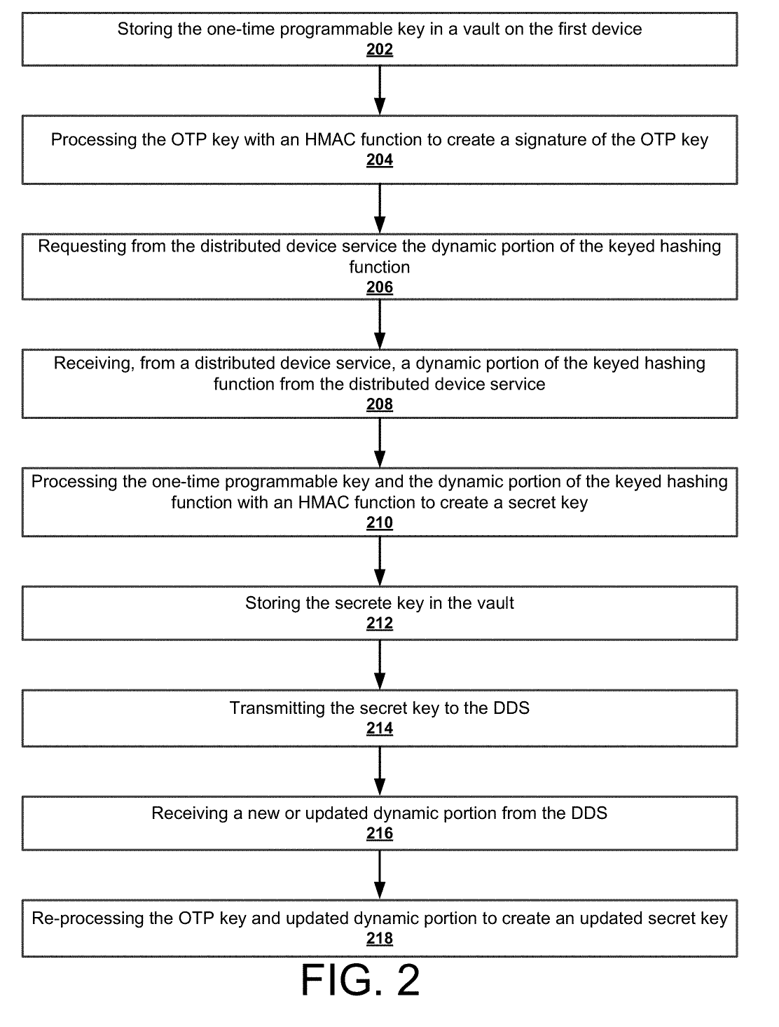

FIG. 2 illustrates an example method that can be executed by a device of the present disclosure. The method generally relates to a process for creating a zero-knowledge security key. In some embodiments, the method includes an optional initial step 202 of storing the one-time programmable key in a vault on the first device. This step is optional as the device may be created with the one-time programmable key stored in hardware. Again, this storage includes storing the OTP in secured memory, which is the vault.

In some embodiments, the method can include a step 204 of processing the OTP key with an HMAC function to create a signature of the OTP key. This information can be used to authenticate the device with the DDS 104.

Next, the method comprises a step 206 of requesting from the distributed device service the dynamic portion of the keyed hashing function. In some embodiments, this step is executed automatically when the device is connected to a network. The request can comprise the OTP key and signature generated by the first device. Possession of both of these values by the first device allows the DDS to authenticate the first device. In some embodiments, instructions for calling back to the DDS are included as a part of a software binary that runs on the device. The device comprises a state machine, and if the device is in a zero/uninitialized state, then the instructions will create an activation message that will be sent to the DDS to request the dynamic key. The activation message will be signed with the OTP key, and the publicly available identity of the device (a serial number, for example) will be included in the request.

The method also comprises a step 208 of receiving, from a distributed device service, a dynamic portion of the keyed hashing function from the distributed device service. Again, this can involve receiving signed entropy from the DDS, such as a randomly generated number.

It will be understood that the signed entropy value of the dynamic portion can be changed as desired. The DDS can change the dynamic portion over time, which results in a corresponding change in the keyed hashing function. Re-provisioning the device with an updated dynamic portion of the keyed hashing function provides a means for revoking or changing services or hardware that is authorized for use on or by the device. For example, if the device is provided with a first signed entropy input and a first secret key is created, the DDS can push a new or second signed entropy input down to the device. This change results in the creation of a new or updated keyed hashing value when the second signed entropy input is XORd with the static portion of the keyed hashing value. Because the first and second signed entropy inputs are different, the resultant secret keys will be different from one another. In another example, changing the dynamic portion of a single device in a group of devices can function to disallow the single device to communicate with the other remaining devices in the group. Thus, these processes can be used to add or remove the device from a group, to add or remove functionality or access to a service, add or remove hardware functionality within the device, and so forth—just to name a few.

In some embodiments, the method includes a step 210 of processing the one-time programmable key and the dynamic portion of the keyed hashing function with an HMAC function to create a secret key. As mentioned above, the secret key is unknown to the hardware component of the first device. In some embodiments, the first random number (OTP) and the second random number (signed entropy) are processed to create a resultant value.

Next, the method includes a step 212 of storing the secret key in the vault.

In some embodiments, the method includes another optional step of transmitting the secret key to the DDS in step 214. The secret key is thus symmetric with a stored key kept on the DDS.

The method can also include an optional step 216 of receiving a new or updated dynamic portion from the DDS. The method then includes a step 218 of re-processing the OTP key and updated dynamic portion to create an updated secret key. As mentioned above, the updated dynamic portion can include a new set of entropy bits, such as a random number. As this dynamic portion changes, a corresponding change in a behavior of the keyed hashing function produces a new secret key. This functionality can be implemented as instructions, that when executed, control the behavior of the device. These executable instructions are responsible for generating key update requests, or for listening to and receiving key update commands.

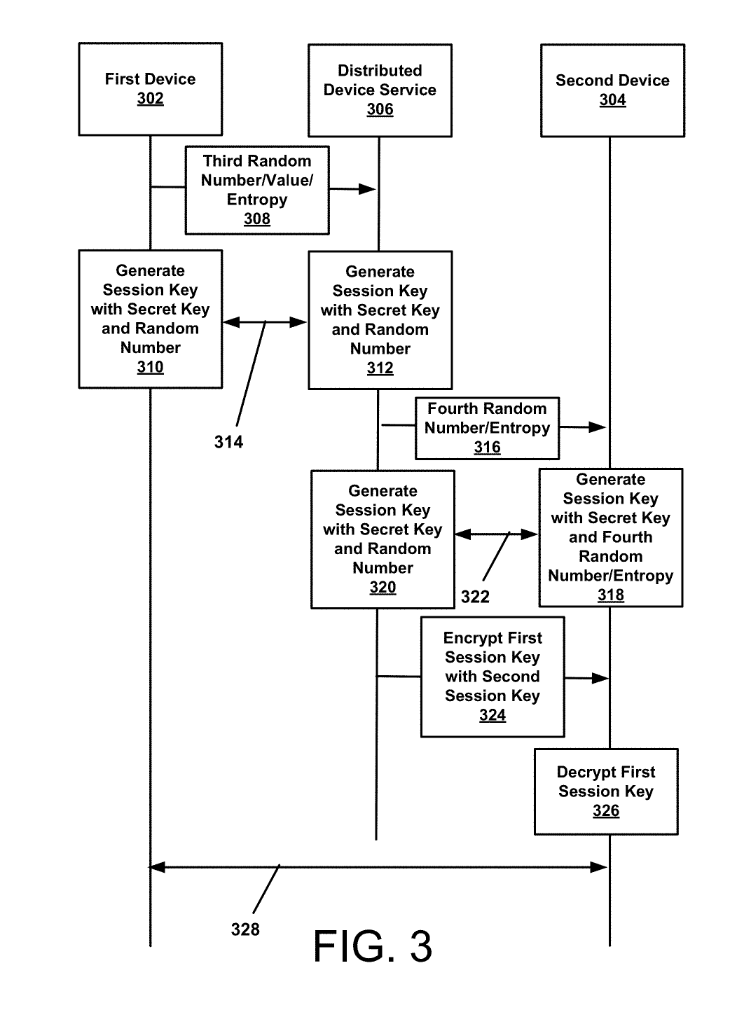

FIG. 3 illustrates an example signal flow diagram of a method for establishing a trust relationship between a first device 302 and a second device 304. This trust relationship is mediated by a distributed device service 306.

Prior to the execution of this method, each device has been provisioned with a secret key in accordance with the embodiments described above.

In some embodiments, the method includes the first device 302 generating a third set of bits of entropy, such as a random number string. Again, for clarity, the first and second sets of bits of entropy were described above and used to generate the secret key.

In one embodiment, the method includes a step of transmitting to the DDS 306 the third set of bits of entropy in step 308. In a subsequent or contemporaneous step 310, a session key for the first device 302 is generated. This includes the first device 302 processing the third set of bits of entropy with the resident secret key using HMAC function in step 310.

The DDS 306 can utilize the third set of bits of entropy to generate an identical version of the session key created by the first device 302 in step 312. This is possible due to the fact that the secret key for the first device 302 is mirrored in the DDS 306 and the DDS 306 is likewise provisioned with AES.

When the session keys match, a secure connection 314 or trust relationship with the DDS 306 is created.

Next, the DDS 306 generates a fourth set of bits of entropy, such as a random number that is transmitted to the second device 304 in step 316. The second device 304 processes the fourth set of bits of entropy using its secret key and HMAC function to create a second session key in step 318. The DDS 306 also creates an identical session key to that which exists on the first device 302 using mirrored information of the second device 304.

Generally speaking, the session keys are secondary types of keys which are derived from the secret keys created on each of the devices in step 320. This creates a trusted path 322 and/or trust relationship between the DDS 306 and second device 304.

To set up the trust relationship, the DDS 306 can encrypt the session key created by/for the first device 302 with the session key created by/for the second device 304. This can be accomplished using the resident AES functionality in the DDS 306.

This session key is referred to as the encrypted session key for clarity of description. Step 324 includes the encrypted session key being transmitted to the second device 304.

The second device 304 then decrypts the encrypted session key using its provisioned AES functionality to recover the first session key in step 326. The trust relationship can be established because the second device 304 has the session key created by the first device 302. This trust relationship is identified as path 328

This trust relationship can be unilateral or bilateral. For example, the relationship can be defined such that the first device 302 trusts the second device 304, but that the second device 304 does not trust the first device 302. Thus, the first device 302 may receive data from the second device 304, but the second device 304 does not receive data from the first device 302.

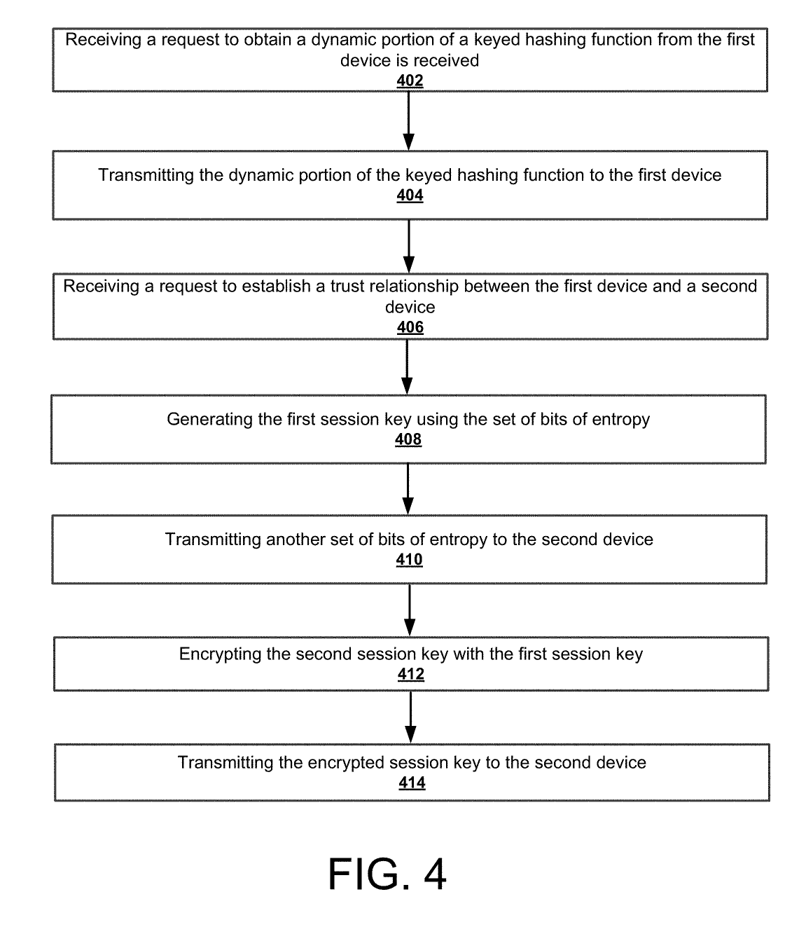

FIG. 4 is a flowchart of an example method that is executed by a distributed device service. The method comprises the provision of dynamic portion of keyed hashing functions, the mirroring of secret device keys, and the creation of trust relationships between devices that each includes a zero-knowledge secret key described herein.

In this method, upon initial device activation of a first device, a step 402 of receiving a request to obtain a dynamic portion of a keyed hashing function from the first device is received. The request can comprise an OTP key for the first device that was previously mirrored in the DDS. The request can also comprise a signature of the DDS created by the first device. If the first device is authenticated, the method includes a step 404 of transmitting the dynamic portion of the keyed hashing function to the first device.

Next, the method can comprise a step 406 of receiving a request to establish a trust relationship between the first device and a second device. This request comprises a set of bits of entropy used to create a first session key by the first device. The first device retains the first session key.

The method also comprises a step 408 of generating the first session key using the set of bits of entropy. This can include processing the set of bits of entropy with a symmetric version of the keyed hashing function for the first device to create a first session key, the first device having also created the first session key.

In some embodiments, a secure channel is established with the first device using the first session key. In some embodiments, the method includes a step 410 of transmitting another set of bits of entropy to the second device. It will be understood that the second device creates a second session key using the another set of bits of entropy. The DDS also creates this same second session key that mirrors the one created by the second device using the another set of bits of entropy.

Next, the method includes a step 412 of encrypting the second session key with the first session key, as well as step 414 of transmitting the encrypted session key to the second device. To be sure, the second device can decrypt the encrypted session key to recover the first session key and establish a secure session with the first device. The second device can then share the first session key with the first device as a means of authenticating the second device.

FIG. 5 is a schematic diagram of an example process for using both a static OTP key and dynamic key, which are used as an HMAC secret and processed using an HMAC hashing function. In more detail, an OTP static key 502, which is embedded in a device, is combined with a dynamic key portion 504, referred to as an activation key. This activation key is received from the DDS as described above. A key mixing function 506 is utilized to combine the OTP static key 502 with the dynamic key portion 504 to create a combined key 508. The combined key 508 is then processed, along with any additional data 510 using a hashing function 512, which in some embodiments is an HMAC function to generate a message authentication code 514. Again, these processes occur both on the device that is embedded with the OTP static key 502, and on the DDS so that both the device and DDS have symmetric message authentication codes.

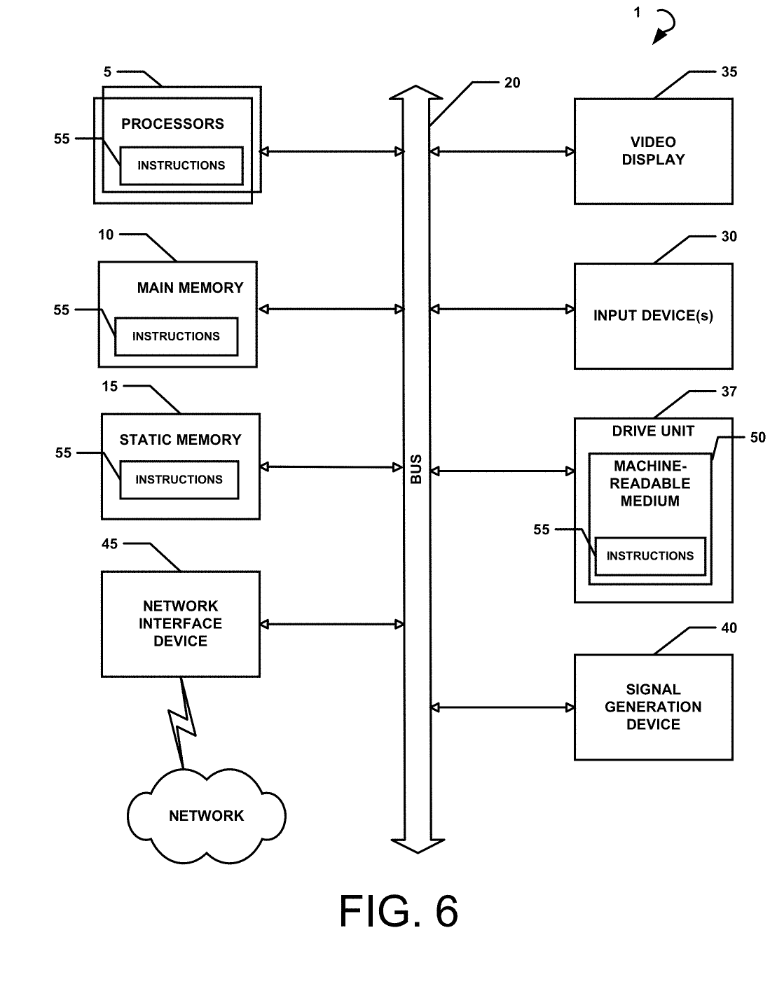

FIG. 6 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 105B or network 520, see FIG. 1 and FIG. 5, respectively) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for creating a zero-knowledge security key, the method comprising:
storing a one-time programmable key in a vault on a first device, the one-time programmable (OTP) key forming a static portion of a keyed hashing function, wherein the OTP key is usable but unknown to the first device;
receiving, from a distributed device service, a dynamic portion of the keyed hashing function from the distributed device service;
cryptographically processing the OTP key and the dynamic portion of the keyed hashing function to create a first secret key; and
storing the first secret key in the vault.

2. The method according to claim 1, further comprising provisioning the first device with an advanced encryption standard that is used to create the first secret key from the static portion and the dynamic portion, and wherein the OTP key comprises a first set of bits of entropy.

3. The method according to claim 2, further comprising upon initiation of the first device, requesting from the distributed device service the dynamic portion of the keyed hashing function, which comprises a second set of bits of entropy.

4. The method according to claim 3, wherein as the second set of bits of entropy of changes, a behavior of the keyed hashing function changes to create an updated secret key.

5. The method according to claim 1, further comprising:
processing the OTP key with an HMAC function to create a signature of the OTP key; and
transmitting the OTP key and signature to the distributed device service.

6. The method according to claim 1, wherein cryptographically processing comprises applying an XOR function to the static portion and the dynamic portion.

7. The method according to claim 1, wherein the first secret key is mirrored in the distributed device service as an identifier for the first device and a means for generating encrypted session keys for the first device.

8. The method according to claim 1, further comprising generating and storing a second secret key of a second device using the method of claim 1.

9. The method according to claim 8, wherein a unilateral or bilateral trust relationship can be established between the first device and the second device using the first secret key and the second secret key based on derivation of session keys therefrom.

10. The method according to claim 9, further comprising:
creating a first session key in the vault of the first device that corresponds to a first identical session key generated by the distributed device service for the first device; and
creating a second session key in the vault of the second device that corresponds to a second identical session key generated by the distributed device service for the second device.

11. The method according to claim 10, wherein creating the first session key comprises:
generating a third set of bits of entropy by the first device;
transmitting the third set of bits of entropy to the distributed device service;
processing the third set of bits of entropy with the first secret key to obtain the first session key; and
wherein creating the second session key comprises:
receiving, by the second device, a fourth set of bits of entropy from the distributed device service; and
processing the fourth set of bits of entropy with the second secret key to obtain the second session key.

12. The method according to claim 11, further comprising mirroring the second session key at the distributed device service.

13. The method according to claim 12, further comprising creating a secured pathway or trust relationship between the first device and the second device by:
transmitting an encrypted session key to the second device, the encrypted session key being created from the first session key and the second session key; and
decrypting, by the second device, the encrypted session key.

14. The method according to claim 13, further comprising establishing a secure communication channel or trusted relationship between the first device and the second device using the decrypted session key.

15. The method according to claim 1, further comprising:
receiving the OTP key; and
storing the OTP key in a hardware component of the first device.

16. The method according to claim 15, wherein the OTP key is stored in a secure memory space on the hardware.

17. A method, comprising:
upon initial device activation of a first device, receiving a request to obtain a dynamic portion of a keyed hashing function from the first device, the first device being previously provisioned with a one-time programmable key stored in a hardware component of the first device, the one-time programmable key being a static portion of the keyed hashing function;
transmitting the dynamic portion of the keyed hashing function to the first device;
receiving a request to establish a trust relationship between the first device and a second device;
receiving a set of bits of entropy from the first device;
processing the set of bits of entropy with a symmetric version of the keyed hashing function for the first device to create a first session key, the first device having also created the first session key;
establishing a secure channel with the first device using the first session key;
transmitting another set of bits of entropy to the second device, the second device creating a second session key using the another set of bits of entropy;
encrypting the second session key with the first session key; and
transmitting the encrypted session key to the second device, wherein the second device can decrypt the encrypted session key to recover the first session key and establish a secure session with the first device.

18. The method according to claim 17, further comprising upon initial device activation of the second device, transmitting to the second device, a dynamic portion of the keyed hashing function for the second device.

19. A system, comprising:
a distributed device service that distributes, to devices, dynamic portions of a keyed hashing function, wherein the devices embed a static portion of the keyed hashing function, and are each configured to create a secret key from pairs of the static portions and the dynamic portions, further wherein the secret key is used to generate encrypted session keys that are utilized to facilitate any of secure sessions and trusted relationships between one or more of the devices, wherein the secret key is unknown to a processor of the device to which it belongs.

20. The system according to claim 19, wherein the dynamic portions of the keyed hashing function are requested from the distributed device service using the static portions of the keyed hashing function, the static portions comprising one-time programmable keys, further wherein the one-time programmable keys and the secret key are stored in a vault that is in a secure memory space of the devices.
